(19) United States
(12) Patent Application Publication
(10) Pub. No.: US 2002/0061749 A1
(43) Pub. Date: May 23, 2002

(54) Enhanced inter-generation CDMA hard-handoff procedure

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 09/990,009

(22) Filed: Nov. 20, 2001

Related U.S. Application Data
(60) Provisional application No. 60/252,499, filed on Nov. 21, 2000.

(51) Int. Cl. H04Q 7/20

(52) U.S. Cl. 455/436; 455/439

(57) ABSTRACT

A wireless communication system performs a handoff in a manner to increase the likelihood of success. A threshold is computed by which the indicator of the target system must exceed the indicator of the source system that is based on the dynamics of the mobile or signal conditions local to the mobile. The indicator may be RTD or Ec/Io of the pilot(s) or otherwise. When the threshold level is exceeded, the mobile station is handed off to the target base station.

### CROSS-REFERENCE TO RELATED APPLICATIONS

This application claims benefit of U.S. Provisional application No. 60/252,499, filed Nov. 21, 2000, the content of which is incorporated herein by reference in its entirety.

### TECHNICAL FIELD

This invention relates to wireless communication systems, and more particularly to enhanced handoff control for wireless communication systems.

### BACKGROUND

Cellular telephones may operate under a variety of standards including the code division multiple access (CDMA) cellular telephone communication system for which a 2^{nd} generation system is described in TIA/EIA, http://164.195.100.11/netacgi/nph-Parser?Sect1=PTO2&Sect2=HITOFF&p=1&u=/netahtml/-h22http://164.195.100.11/netacgi/nph-Parser?Sect1=PTO2&Sect2=HITOFF&p=1&u=/netahtml/-h24IS-95, Mobile station-Base Station Compatibility Standard for Dual-Mode Wideband Spread Spectrum Cellular System, published July 1993 and a 3^{rd} generation system is described in TIA/EIA, IS-2000-A Volumes 1 through 6. CDMA is a technique for spread-spectrum multiple-access digital communications that creates channels through the use of unique code sequences. In CDMA systems, signals can be and are received in the presence of high levels of interference. The practical limit of signal reception depends on the channel conditions, but CDMA reception in the system described in the aforementioned http://164.195.100.11/netacgi/nph-Parser?Sect1=PTO2&Sect2=HITOFF&p=1&u=/netahtml/-h23http://164.195.100.11/netacgi/nph-Parser?Sect1=PTO2&Sect2=HITOFF&p=1&u=/netahtml/-h25IS-95 Standard can take place in the presence of interference that is 18 dB larger than the signal for a static channel. Typically, the system operates with a lower level of interference and dynamic channel conditions.

A mobile station using the CDMA standard constantly searches a Pilot Channel of neighboring base stations for a pilot that is sufficiently stronger than a threshold value. As the mobile station moves from the region covered by one base station to another, the mobile station promotes certain pilots from the Neighbor Set to the Candidate Set, and notifies the base station or base stations of the promotion from the Neighbor Set to the Candidate Set via a Pilot Strength Measurement Message. The base station determines an Active Set according to the Pilot Strength Measurement Message, and notifies the mobile station of the new Active Set via a Handoff Direction Message. When the mobile station commences communication with a new base station in the new Active Set before terminating communications with the old base station, a “soft handoff” has occurred. When the mobile station commences communication with a new base station in the new Active Set after terminating communications with the old base station, a “hard handoff” has occurred.

The existing methodologies of providing a trigger for inter-generation hard handoff (IGHH) use Round Trip Delay (RTD) or Ec/Io as mechanisms to detect the mid-point (either in terms of chip energy to interference or in terms of signal path) between fringe base stations from source and target generation systems. The problem with these mechanisms is that the mid-point is generally not the best point to handoff. This is due to the fact that a mobile may be on the border of two systems or may approach the border but then reverse direction, etc. Using the mid-point as a means of triggering an IGHH is not optimal because the handoff trigger may occur either too early or too late. It is generally incorrect to assume that all mobiles will always be traveling directly from a source system toward a target system at a constant speed or such. The proposals to use equi-distant RTD or Ec/Io cater to this incorrect assumption. This invention provides a solution to this problem.

### SUMMARY

The invention consists of a method of handoff of a mobile terminal communications between wireless systems of the same or different generations. One example, would be a handoff from a 3G system such as IS-2000-A and a 2G system such as IS-95.

The invention involves computing a threshold by which the indicator of the target system must exceed the indicator of the source system that is based on the dynamics of the mobile or signal conditions local to the mobile. The indicator may be RTD or Ec/Io of the pilot(s) or otherwise. The source system (or source generation) in this document refers to the system that the mobile has been on. The target system (or target generation) refers to the system that the mobile is considering handoff to and may be in soft-handoff with (in addition to the source system) or, that the mobile may simply have an active pilot(s) allocated from, or that the mobile may be transitioning toward.

An example of such a threshold is an Ec/Io increment (delta value) that depends on the current variance of the source and/or destination system pilot levels. More specifically, the threshold may be set to equal a constant multiplied by the standard deviation of the total pilot Ec/Io level measured over a period of N milliseconds or such.

### DESCRIPTION OF DRAWINGS

These and other features and advantages of the invention will become more apparent upon reading the following detailed description and upon reference to the accompanying drawings.

FIG. 1 illustrates the components of an exemplary wireless communication system used by one embodiment of the present invention.

FIG. 2 is an illustration of a portion of a wireless communication system.

FIG. 3 illustrates the process of triggering a handoff according to one embodiment of the present invention.

FIG. 4 illustrates an example of a handoff process according to one embodiment of the present invention.

FIG. 5 illustrates a further example of a handoff process according to one embodiment of the present invention.

### DETAILED DESCRIPTION

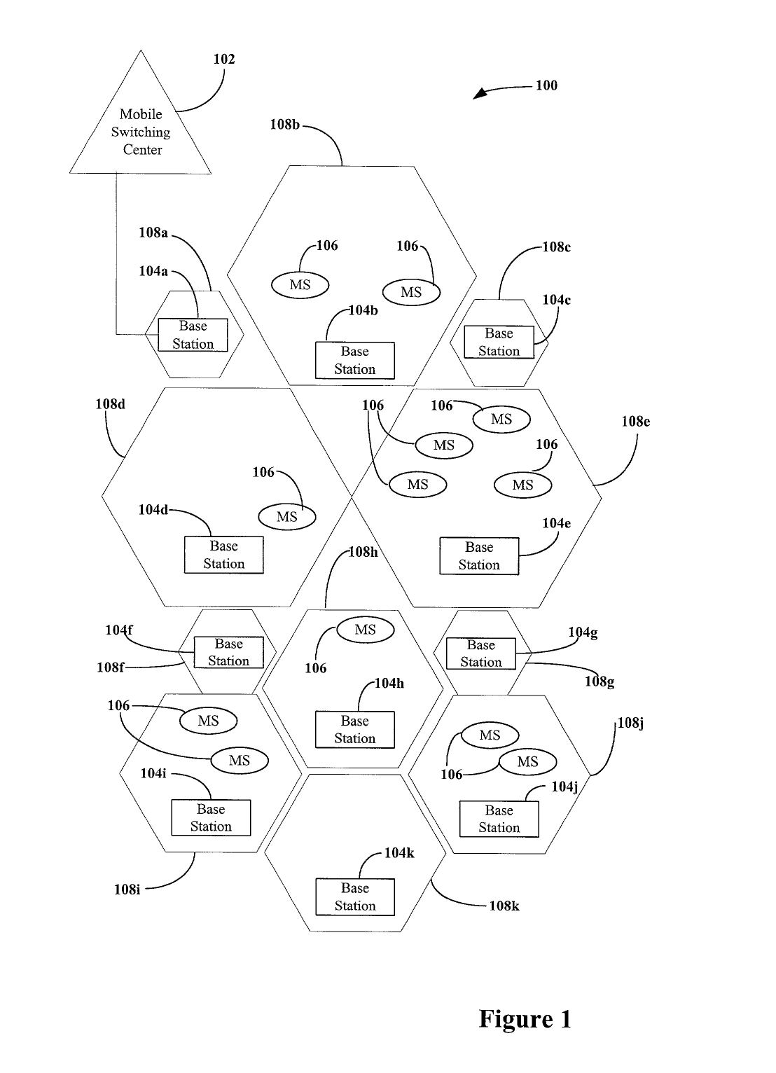

FIG. 1 illustrates components of an exemplary wireless communication system. A mobile switching center 102 communicates with base stations 104a-104k (only one connection shown). The base stations 104a-104k (generally 104) broadcasts data to and receives data from mobile stations 106 within cells 108a-108k (generally 108). The cell 108 is a geographic region, roughly hexagonal, having a radius of up to 35 kilometers or possibly more.

A mobile station 106 is capable of receiving data from and transmitting data to a base station 104. In one embodiment, the mobile station 106 receives and transmits data according to the Code Division Multiple Access (CDMA) standard. A set of standards that define a version of CDMA that is particularly suitable for use with the invention include IS-95, IS-95A, and IS-95B, Mobile Station-Base Station Compatibility Standard for Dual-Mode Spread Spectrum Systems; TIA/EIA/IS-2000-2, Physical Layer Standard for cdma2000 Spread Spectrum Systems; and TIA/EIA/IS-2000-5 Upper Layer (Layer 3) Signaling Standard for cdma2000 Spread Spectrum Systems, all of which are herein incorporated by reference in their entirety. CDMA is a communication standard permitting mobile users of wireless communication devices to exchange data over a telephone system wherein radio signals carry data to and from the wireless devices.

Under the CDMA standard, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone scans certain frequencies (frequencies known to be used by CDMA) to synchronize communication with the base station 104. The cellular telephone then registers with the mobile switching center 102 to make itself known as an active user within the CDMA network.

When detecting a call, the cellular telephone scans data frames broadcast by the base station 104 to detect any telephone calls or paging messages directed to the cellular telephone. In this call detection mode, the cellular telephone receives, stores and examines paging message data, and determines whether the data contains a mobile station identifier matching an identifier of the cellular telephone. If a match is detected, the cellular telephone establishes a call with the mobile switching center 102 via the base station 104. If no match is detected, the cellular telephone enters an idle state for a predetermined period of time, then exits the idle state to receive another transmission of paging message data.

At times it is desirable for a different base station 104 to communicate with the mobile station 106. This may be due to the original base station 104 losing signal strength, the mobile station 106 traveling out of range of the original base station 104, or other factors. When the mobile station 106 changes base stations 104, it is referred to as a handoff. Currently, one technique for determining if a handoff is to occur is to monitor the energy level of a pilot signal from a base station. If the energy level of the pilot signal falls below a predetermined threshold for a specific period of time, the mobile station 106 initiates a handoff.

One example of such a mobile station 106 is a cellular telephone used by a vehicle driver who converses on the cellular telephone while driving in a cell 108b. Referring to FIG. 1B, a portion of a wireless system is shown. The cellular telephone synchronizes communication with the base station 104b by monitoring a pilot that is generated by the base station 104b. While powered on, the mobile station 106 continues to scan predetermined CDMA system frequencies for pilots from other base stations 104 such as the pilots from the base stations 104d and 104e as well as the pilot corresponding to the base station 104b. Upon detecting a pilot from another base station 104d, the mobile station 106 initiates a handoff sequence to add the pilot to the Active Set. Likewise, upon determining that the energy level of an Active Set pilot has weakened sufficiently and the handoff timeout value, T_TDROP, has been exceeded, the mobile station 106 initiates a handoff sequence to drop the pilot.

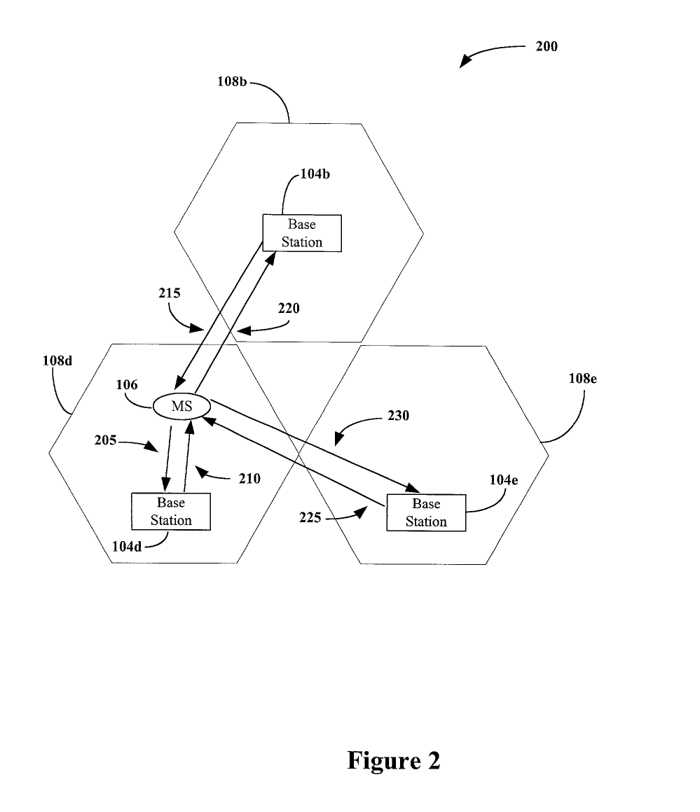

FIG. 2 illustrates a mobile station in communication with active sectors according to one embodiment of the present invention. For purposes of illustration, FIG. 2 only shows a portion of the wireless communication system of FIG. 1 comprising an active set 200 of base stations 104b, 104d, and 104e. The signaling and traffic from the active set sectors 200 includes the information necessary for the mobile station 106 to maintain a call. Each of the base stations 104b, 104d, and 104e in the active set 200 transmits to the mobile station 106 on forward channels 210, 215, and 225. The mobile station 106 communicates back to the base stations 104b, 104d, and 104e over reverse channels 205, 220, and 230. The forward channels 210, 215, and 225 and the reverse channels 205, 220, and 230 may be any channel used in the wireless cellular system. These include, but are not limited to, the Traffic Channel (TCH), the Dedicated Control Channel (DCCH), the Supplemental Channel (SCH), and the Supplemental CodeChannel (SCCH) as per IS2000-A.

At any time, one of the base stations 104b, 104d, and 104e is selected as the reference active sector. The reference is used as a timing reference for transmission as well as demodulation. The other stations in the active set 200 are used for demodulation and also maintained in case the mobile station 106 needs use them as a reference.

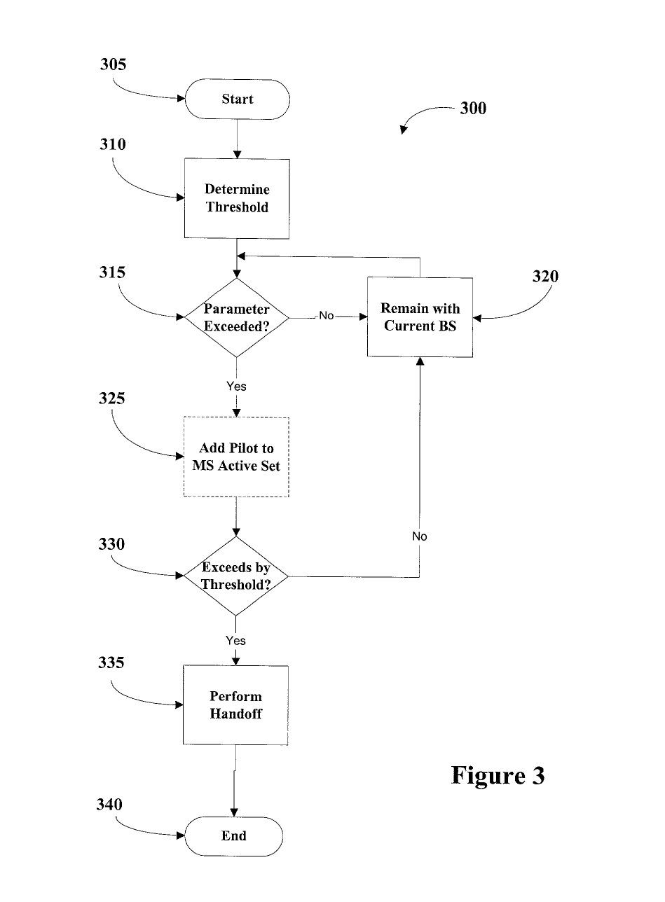

FIG. 3 illustrates a process 300 for determining when to initiate a handoff according to one embodiment of the present invention. The process 300 begins at a START block 305. Proceeding to block 310, the process 300 determines a threshold level to initiate handoff. The threshold level is a level that the target system exceeds the source system at a given time. The threshold level may be predetermined, dynamically adjusted based on historical data, set by the base station, set by the mobile station, or any other manner of determining the threshold. Instead of using an Ec/Io threshold determined by, or fixed in, the mobile, the infrastructure could also send a parameter (say T_IGHH_COMP) which identifies what threshold level the mobile shall use. This can be done as overhead information or specifically on a Inter-Generation Hard-Handoff message or instruction. Or, alternatively, instead of, or in combination with an Ec/Io level threshold, the system could use a time-value (say T_TIGHH) much like the existing IS-2000 T_TDROP drop timer. For example, this timer would expire after the target system has been preferable to the target system for T_TIGHH seconds. Other examples of inputs to the threshold determination include how close the pilot (source and/or target) Ec/Io's are to T_DROP (or other point at which the signal is considered too weak or undesirable), past history of pilot energy or other channel strength, dynamics or location information, or variance (or standard deviation) of the pilot energy over a period of time or some filtered strength. Additionally, the indicator may include other elements in addition to Ec/Io such as RTD or strength of a number of pilots from either source or target generation system.

Proceeding to block 315, the process 300 determines if the monitored parameter of the target system exceeds the base level. The monitored parameter may be any parameter indicating the quality of the pilot signal, such as Ec/lo or other signal strength measurement. The base level may be set to a level where handoff with the target base station may be achieved. If the monitored parameter does not exceed the base level, the process 300 proceeds along the NO branch to block 320. In block 320, the mobile station 106 remains with the current base station 104 and does not perform a handoff. The process 300 then loops back to block 315 to continue monitoring the parameter.

If the monitored parameter does exceed the base level, the process 300 proceeds along the YES branch to block 325. Note that block 325 is optional, and if not desired the process 300 will proceed directly to block 330. In optional block 325, the base station 104 of the source system may send a message adding the identified pilot of the target system to the active set of the mobile station 106.

Proceeding to block 330, the process 300 determines whether the target pilot parameter exceeds the source pilot parameter by at least the threshold level. By ensuring the target pilot parameter exceeds the source by the threshold level, the process 300 ensures a quality handoff may occur. If the target does not exceed the source by the threshold, the process 300 proceeds along the NO branch back to block 320, where the mobile station 106 remains with the current base station 104 and does not perform a handoff.

Returning to block 330, if the target pilot parameter does exceed the source pilot parameter by at least the threshold level, the process 300 proceeds along the YES branch to block 335. In block 335, the mobile station 106 is handed off to the target base station. The process 300 then terminates in an END block 340.

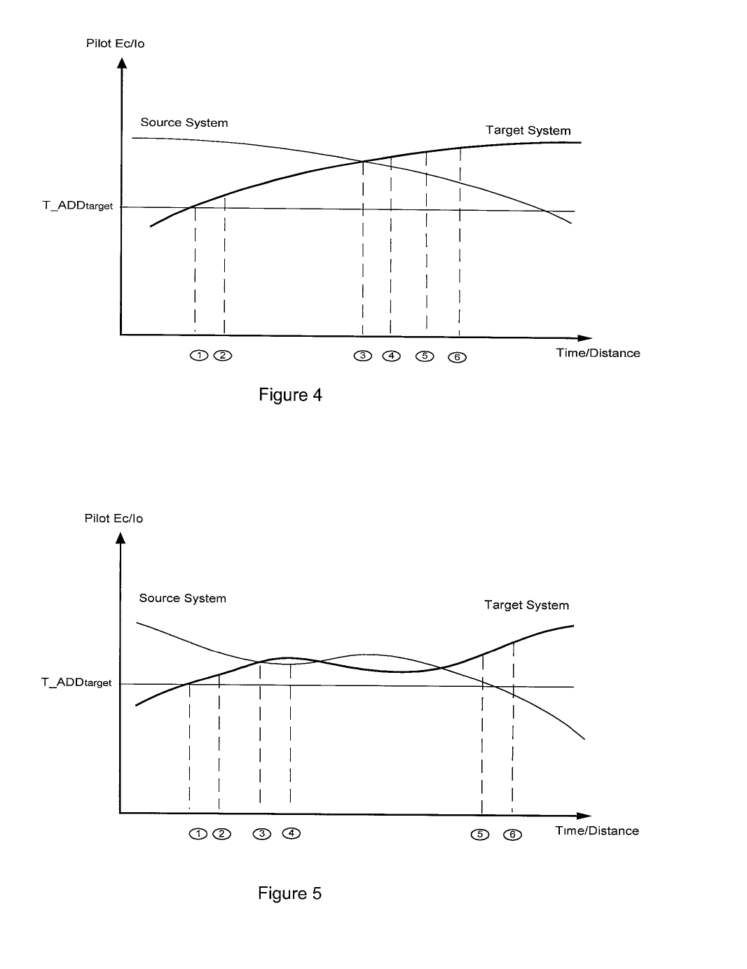

FIG. 4 illustrates a simple scenario where the mobile station 106 is moving directly from the source system toward the target system. FIG. 5 illustrates a more complex situation that is also more typical of mobile dynamics. Note that in FIG. 5, with the present invention, the mobile station 106 waits until the handoff is more likely to succeed. Using the equidistant method of the prior art would result in the following sequence of events:

1) the mobile station 106 sends a Pilot Strength Measurement Message (or other indication) indicating that the target system pilot (or pilots) has exceeded T_ADD (see (1) in FIGS. 4 and 5).

2) the base station of the source system may optionally send a message adding the identified (or other pilots expected to be of use to the mobile based on the report) pilot(s) of the target system to the mobile's active set. This is optional. (see (2) in FIGS. 4 and 5).

3) the mobile station 106 recognizes that the Ec/Io's are equal and (see (3) in FIGS. 4 and 5), and the mobile station 106 sends an indication of such on the reverse link (or periodic reports are sent on the reverse link), and the base station (source) sends a command to complete the hard-handoff at that time (see (4) in FIGS. 4 and 5), or the mobile station 106 completes the inter-generation hard-handoff autonomously.

Using the process according to the present invention, the mobile station 106 will instead perform the following sequence of actions:

1) the mobile station 106 sends a Pilot Strength Measurement Message (or other indication) indicating that the target system pilot (or pilots) has exceeded T_ADD (see (1) in FIGS. 4 and 5).

2) the base station of the source system may optionally send a message adding the identified (or other pilots expected to be of use to the mobile based on the report) pilot(s) of the target system to the mobile's active set. (see (2) in FIGS. 4 and 5).

3) the mobile station 106 recognizes that the target pilot Ec/Io exceeds the source pilot Ec/Io by at least the inter-generation Ec/Io threshold and (see (5) in FIGS. 4 and 5), and either sends indication of such on the reverse link (or periodic reports are sent on the reverse link), and the base station (source) sends a command to complete the hard-handoff at time (6), or the mobile station 106 completes the inter-generation hard-handoff autonomously by time (see (6) in FIGS. 4 and 5).

In the above examples, where the threshold is based on energy variance, the mobile would compute the variance or representation thereof in real-time and choose a small threshold if the variance is low and a large threshold if the variance is high. In such a case, the present invention would result in quick handoff if the pilots are generally predictable or have low variance and delay the handoff if the mobile is unsure of the energy levels.

Numerous variations and modifications of the invention will become readily apparent to those skilled in the art. Accordingly, the invention may be embodied in other specific forms without departing from its spirit or essential characteristics.

What is claimed is:

1. A method of triggering handoff from a first wireless communication system comprising:
detecting at least one pilot signal from a second wireless communication system of a different generation from said first wireless communication system;
measuring at least one target parameter from said second wireless communication system;
measuring at least one source parameter from said first wireless communication system;
determining a threshold level; and
detecting when said target parameter exceeds said source parameter by said threshold level.

2. The method of claim 1, further comprising completing handoff to said second wireless communication system upon said detection.

3. The method of claim 1, further comprising adding said at least one pilot from said second wireless communication system to an active set.

4. The method of claim 1, further comprising dynamically adjusting the threshold value.

5. The method of claim 1, wherein at least one of the source parameter or target parameter is a pilot signal strength.

6. The method of claim 1, further comprising sending instructions for completing a handoff.

7. The method of claim 1, further comprising completing a handoff autonomously.

8. The method of claim 1, further comprising determining a statistic of one or more of said at least one source parameter and said at least one target parameter.

9. The method of claim 8, wherein determining the threshold level comprises computing the threshold level based on said statistic.

10. The method of claim 1, wherein said threshold level is communicated to a mobile station from a base station.

11. The method of claim 10, wherein said communication of said threshold level is part of an inter-generation handoff message.

12. The method of claim 2, wherein handoff to said second wireless communication system occurs a predetermined time after said detection is made and remains true.

13. The method of claim 12, wherein said predetermined time is calculated based on one of the group consisting of a proximity of a source pilot signal to a drop threshold, a proximity of a target pilot signal to a drop threshold, a weakness of a source pilot signal, a past history of a source pilot energy, a past history of a target pilot energy, and a filtered pilot energy.

14. The method of claim 1, wherein determining said threshold level comprises calculating said threshold based on one of the group consisting of a proximity of a source pilot signal to a drop threshold, a proximity of a target pilot signal to a drop threshold, a weakness of a source pilot signal, a past history of a source pilot energy, a past history of a target pilot energy, and a filtered pilot energy.

15. The method of claim 1, wherein at least one of said source parameter or target parameter is a round-trip delay value.

16. The method of claim 1, wherein determining said threshold value comprises evaluating two or more pilot strengths.

17. A system for enabling handoff from a first wireless communication system to a second wireless communication system comprising:
a first wireless communication system comprising a plurality of base stations which each transmit a signal;
a second wireless communication system of a different generation than said first wireless communication system, comprising a plurality of base stations which each transmit a signal;
a mobile station which detects at least one pilot signal from said second wireless communication system, wherein the mobile station measures at least one target parameter from said second wireless communication system and at least one source parameter from said first wireless communication system, wherein the mobile station determines a threshold level and detects when said target parameter exceeds said source parameter by said threshold level.

18. The system as recited in claim 17, wherein the mobile station completes handoff to said second wireless communication system upon said detection.

19. The system as recited in claim 17, wherein the mobile station adds said at least one pilot from said second wireless communication system to an active set.

20. The system as recited in claim 17, wherein the mobile station dynamically adjusts the threshold value.

21. The system as recited in claim 17, wherein at least one of said source parameter or target parameter is a pilot signal strength.

22. The system as recited in claim 17, wherein said mobile station receives instructions for handoff from a base station.

23. The system as recited in claim 17, wherein said mobile station completes handoff autonomously.

24. The system as recited in claim 17, wherein said mobile station determines a statistic of one or more of said at least one source parameter and said at least one target parameter.

25. The system as recited in claim 24, wherein said mobile station computes the threshold level based on said statistic.

26. The system as recited in claim 17, wherein said mobile station receives said threshold level from a base station.

27. The system as recited in claim 26, wherein said threshold level is part of an inter-generation handoff message.

28. The system as recited in claim 17, wherein said mobile station hands off to said second wireless communication system after a predetermined time elapses since said detection is made and remains true.

29. The system as recited in claim 28, wherein said predetermined time is calculated based on one of the group consisting of a proximity of a source pilot signal to a drop threshold, a proximity of a target pilot signal to a drop threshold, a weakness of a source pilot signal, a past history of a source pilot energy, a past history of a target pilot energy, and a filtered pilot energy.

30. The system as recited in claim 17, wherein said mobile station calculates said threshold based on one of the group consisting of a proximity of a source pilot signal to a drop threshold, a proximity of a target pilot signal to a drop threshold, a weakness of a source pilot signal, a past history of a source pilot energy, a past history of a target pilot energy, and a filtered pilot energy.

31. The system as recited in claim 17, wherein said at least one source parameter or said at least one target parameter is a round-trip delay value.

32. The system as recited in claim 17, wherein said mobile station determines said threshold value by evaluating two or more pilot strengths.
